(19) United States
(12) Patent Application Publication
(10) Pub. No.: US 2008/0288692 A1
(43) Pub. Date: Nov. 20, 2008

(54) SEMICONDUCTOR INTEGRATED CIRCUIT DEVICE AND MICROCOMPUTER

(76) Inventors: Kenichi Mine, Tokyo (JP); Minoru Uemura, Tokyo (JP); Shinichi Oshikawa, Tokyo (JP)

Correspondence Address: MILES & STOCKBRIDGE PC, 1751 PINNACLE DRIVE, SUITE 500, MCLEAN, VA, 22102-3833, US

(21) Appl. No.: 12/101,952

(22) Filed: Apr. 11, 2008

(30) Foreign Application Priority Data
May 18, 2007 (JP) 2007-132674

(51) Int. Cl. G06F 13/24

(52) U.S. Cl. 710/260

(57) ABSTRACT

It is intended to improve the efficiency of request retransmission. A high-speed serial interface block is provided which enables split-transaction communication performed through the issuing of a response from a completer to a request issued by a requester. The high-speed serial interface block mentioned above is provided with a reception butter for retrieving received data and with a control unit for causing execution of a process which is performed in the case where there is no response from the completer mentioned above within a predetermined time when the reception buffer mentioned above has overflown. When the reception buffer mentioned above has overflown, a process of issuing a time out even within a prescribed time for time-out determination is allowed to improve the efficiency of request retransmission.

### CROSS-REFERENCE TO RELATED APPLICATIONS

The disclosure of Japanese Patent Application No. 2007-132674 filed on May 18, 2007 including the specification, drawings and abstract is incorporated herein by reference in its entirety.

### BACKGROUND OF THE INVENTION

The present invention relates to a semiconductor integrated circuit device (semiconductor integrated device) and a microcomputer which enable split-transaction communication performed through the issuing of a response from a completer to a request issued by a requester.

In general, it has been examined to use a high-speed serial interface in place of a parallel interface, such as a PCI bus, in a data processing apparatus such as a microcomputer. For serial interfaces, there are standards including the IEEE 1394 and the USB. However, compared with a PCI interface, such interfaces are insufficient in terms of transfer rate, and it is also difficult to secure scalable bus widths therefor. As another high-speed serial interface, the PCI Express (registered trademark) corresponding to a successor standard to the PCI bus system can be listed. The PCI Express system is constructed as a data communication network having a tree structure (tree-like structure) including a root complex, a switch (optional layer), a device, and the like, such as shown in, e.g., Non-Patent Document 1. As an example of a document describing an image device system aiming at efficient use of the PCI Express system, Patent Document 1 can be listed.
[Non-Patent Document 1]
“Outline of PCI Express Standard”, Takashi Satomi, Interface, July 2003
[Patent Document 1]
Japanese Unexamined Patent Publication No. 2005-148896

### SUMMARY OF THE INVENTION

The PCI Express system supports a split-transaction protocol, and a request that requires a response from a transaction partner, represented by a memory read, is provided with a time-out mechanism for preventing a deadlock. The time-out mechanism is a system which issues a “time out” when there is no response from a transaction partner within a prescribed time or when a response from the transaction partner is not completed within a prescribed time. When the time out is issued, retransmission of the request is performed. However, it has been found by the present inventors that, because a conventional system does not issue a time out before the prescribed time elapses even when the reception buffer of a transaction initiator has overflown with the response from the transaction partner, the efficiency of request retransmission is degraded thereby. In Patent Document 1, there is a description for avoiding the overflow of the reception buffer, but there is no description of the case where an overhead has occurred.

An object of the present invention is to improve the efficiency of request retransmission in split-transaction communication.

The above and other objects and novel features of the present invention will become apparent from the description of the present specification and the accompanying drawings.

As shown below, a brief description will be given to a representative aspect of the invention disclosed in the present application.

That is, a high-speed serial interface block is provided which enables split-transaction communication performed through the issuing of a response from a completer to a request issued by a requester. The high-speed serial interface block mentioned above is provided with a reception buffer for retrieving received data and with a control unit for causing execution of a process which is performed in the case where there is no response from the completer mentioned above within a predetermined time when the reception buffer mentioned above has overflown. When the reception buffer mentioned above has overflown, a process of issuing a time out even within a prescribed time for time-out determination is allowed to improve the efficiency of request retransmission.

The following is a brief description of an effect achievable by the representative aspect of the invention disclosed in the present application.

That is, an improvement in the efficiency of request retransmission in split-transaction communication is achieved.

### BRIEF DESCRIPTION OF THE DRAWINGS

FIG. 1 is a block diagram of an example of a structure of a principal portion of a PCI Express block included in a microcomputer as an example of a semiconductor integrated circuit device according to the present invention;

FIG. 2 is a block diagram of an example of an overall structure of the microcomputer mentioned above;

FIG. 3 is a block diagram of an example of a structure of a PCI Express block included in the microcomputer mentioned above;

FIG. 4 is a flow chart showing a process flow when an interrupt request resulting from the occurrence of an overflow is not issued;

FIG. 5 is a flow chart showing a process flow when the interrupt request resulting from the occurrence of an overflow is issued; and

FIG. 6 is an illustrative view of a time required from the transmission of a memory read request till the occurrence of a time out.

### DETAILED DESCRIPTION OF THE PREFERRED EMBODIMENTS

### Representative Embodiment

First, an outline of a representative embodiment of the invention disclosed in the present application will be described. Reference marks in the drawings which are nestled in parentheses and referenced in the description of the outline of the representative embodiment are only illustrative of the content of the concept of the components provided with the reference marks.

(1) A semiconductor integrated circuit device (210) according to the representative embodiment of the present invention has a high-speed serial interface block (218) which enables split-transaction communication performed through the issuing of a response from a completer to a request issued by a requester. The high-speed serial interface block mentioned above includes a reception butter (11) for retrieving received data and a control unit (15) for causing execution of a process which is performed in the case where there is no response from the completer mentioned above within a predetermined time when the reception buffer mentioned above has overflown.

In the structure mentioned above, when an interrupt request resulting from the occurrence of an overflow is issued, an overflow flag is set when the reception buffer (11) has overflown, and a time-out flag is set in response thereto. As a result, a process of issuing a time out even within a prescribed time for time-out determination is allowed so that, compared with the case where the interrupt request resulting from the occurrence of an overflow is not issued, the efficiency of request retransmission is significantly improved.

(2) The high-speed serial interface block mentioned above may also include the reception buffer (11) for retrieving a received packet, a received packet size counter (12) capable of detecting an overflow in the reception buffer mentioned above by counting the size of the packet received by the reception buffer mentioned above, and the control unit (15) for causing execution of a predetermined interrupt process by setting the time-out flag mentioned above, when the overflow in the reception buffer mentioned above is detected by the received packet size counter, in response thereto.

(3) At this time, it is possible to provide a first register (19) in which the time-out flag is set when there is no response from the completer mentioned above within the predetermined time and a second register (13) in which the overflow flag is set when the overflow in the reception buffer mentioned above is detected by the received packet size counter mentioned above so that, when the overflow flag is set in the second register mentioned above, the time-out flag is set in the first register mentioned above in response thereto.

(4) It is possible to provide a central processing unit (212) capable of executing an interrupt process for request retransmission when the time-out flag is set in the first register mentioned above.

### Description of Embodiments

Next, the embodiments will be described in greater detail.

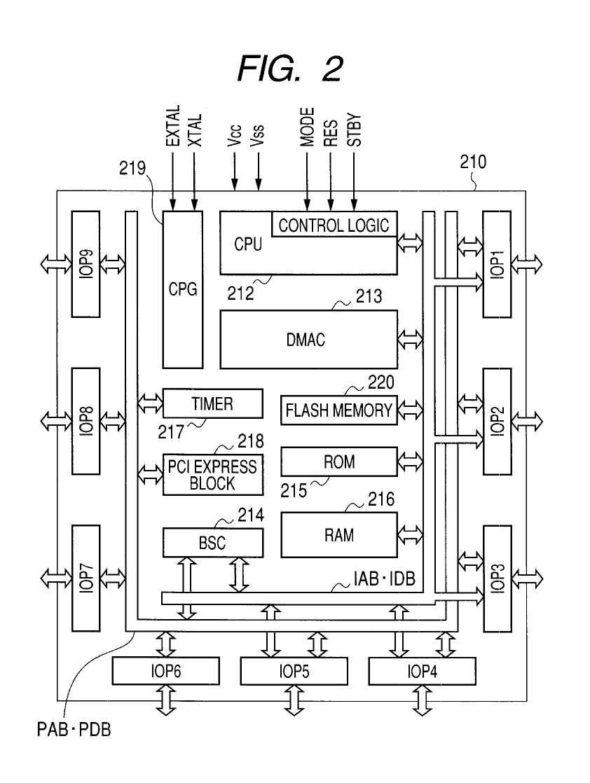

FIG. 2 shows a microcomputer as an example of a semiconductor integrated circuit device according to the present invention. A microcomputer 210 shown in the drawing includes functional blocks or modules which are a flash memory 220, a CPU (Central Processing Unit) 212, a DMAC (Direct Memory Access Controller) 213, a bus controller (BSC) 214, a ROM 215, a RAM 216, a timer 217, a PCI Express block 218, first to ninth input/output ports IOP1 to IOP9, and a clock pulse generator (CPG) 219. The microcomputer 210 is formed in a single semiconductor substrate by a known semiconductor manufacturing technology.

The microcomputer 210 mentioned above has a ground terminal Vss and a power source voltage terminal Vcc as power source terminals for power supply from outside a chip as well as a reset terminal RES, a standby terminal STBY, a mode control terminal MODE, and clock input terminals EXTAL and XTAL as other dedicated control terminals, which are external terminals. The microcomputer 210 operates in synchronization with a system clock generated by the clock pulse generator 219 based on a quartz oscillator, not shown, which is coupled to the clock input terminals EXTAL and XTAL.

The functional blocks mentioned above are coupled to each other by internal buses and thereby allowed to transmit and receive various signals therebetween. The internal buses are comprised of address buses, data buses, and other buses such as control buses containing a read signal, a write signal, a bus size signal, a system clock, and the like. The internal address buses include IAB (internal address bus, first address bus) and PAB (internal peripheral address bus, second address bus). The internal data buses include IDB (internal data bus, first data bus) and PDB (internal peripheral data bus, second data bus). The buses IAB and IDB are coupled to the flash memory 220, the CPU 212, the ROM 215, the RAM 216, the bus controller 214, and some of the input/output ports IOP1 to IOP9. The buses PAB and PDB are coupled to the bus controller 214, the timer 217, the PCI Express block 218, and the input/output ports IOP1 to IOP9. The buses IAB and PAB and the buses IDB and PDB are interfaced by the bus controller 214, respectively. The buses PAB and PDB are exclusively used for a register access in each of the function blocks to which they are coupled, though they are not particularly limited thereto.

The input/output ports IOP1 to IOP9 are used commonly for the inputting/outputting of external bus signals and input/output signals to and from input/output circuits. The input/output ports IOP1 to IOP9 have their functions selected by setting operation modes or software. An external address and external data are coupled to the buses IAB and IDB, respectively, via buffer circuits, not shown, which are included in these input/output ports. The buses PAB and PDB are used to perform read/write operations with respect to embedded registers in the input/output ports, the bus controller 214, and the like and has no direct relation to external buses.

Each of the internal buses and the external buses has a 16-bit bus width so that byte-size (8-bit) and word-size (16-bit) read/write operations are performed. Alternatively, the external bus may also have an 8-bit bus width.

When a system reset signal is applied to the reset terminal RES mentioned above, an operation mode given to a mode control terminal MODE is retrieved so that the microcomputer 210 is brought into a reset state. The operation mode determines which one is to be selected between the validity/invalidity of the embedded ROM 215, between 16 M bytes and 1 M bytes for an address space, between 8 bits or 16 bits for the initial value of the data bus width, and the like, though it is not particularly limited thereto. As necessary, the mode control terminal MODE includes a plurality of terminals and an operation mode is determined by a combination of the respective states of inputs to these terminals.

When the reset state is removed, the CPU 212 reads a start address and performs reset exception handling by which the reading of an instruction from the start address is performed. It is assumed that the start address mentioned above is stored in a region starting at an address zero, though it is not particularly limited thereto. Thereafter, the CPU 212 sequentially executes instructions starting at the start address mentioned above.

The DMAC 213 performs data transfer based on a control operation by the CPU 212. The CPU 212 and the DMAC 213 perform read/write operations using the internal/external buses exclusively to each other. Arbitration of either the CPU 212 or the DMAC 213 is to operate is performed by the bus controller 214.

The bus controller 214 constitutes a bus cycle in response to the operation of the CPU 212 or the DMAC 213. That is, the bus controller 214 forms the bus cycle based on the address signal, the read signal, the write signal, and the bus size signal outputted from the CPU 212 or the DMAC 213. For example, when the CPU 212 outputs an address corresponding to the RAM 216 to the internal address bus IAB, the bus cycle is assumed to be one state so that read/write operations are each performed in one state irrespective of the byte/word size. When the CPU 212 outputs addresses corresponding to the timer 217, the PCI Express block 218, and the input/output ports IOP1 to IOP9, the bus cycle is assumed to be three states so that the content of the internal address bus IAB is outputted to the internal address bus PAB and read/write operations are each performed in three states irrespective of the byte/word size. This control operation is performed by the bus controller 214.

In the microcomputer 210, a user program, tuning information, a data table, and the like are stored appropriately in the flash memory 220. In the ROM 215, a system program such as an operating system is stored, though it is not particularly limited thereto.

The PCI Express block 18 enables serial communication in accordance with the PCI Express (registered trademark), i.e., split-transaction communication performed through the issuing of a response from a completer to a request issued by the requester. The PCI Express block 18 is taken as an example of a high-speed serial interface block according to the present invention.

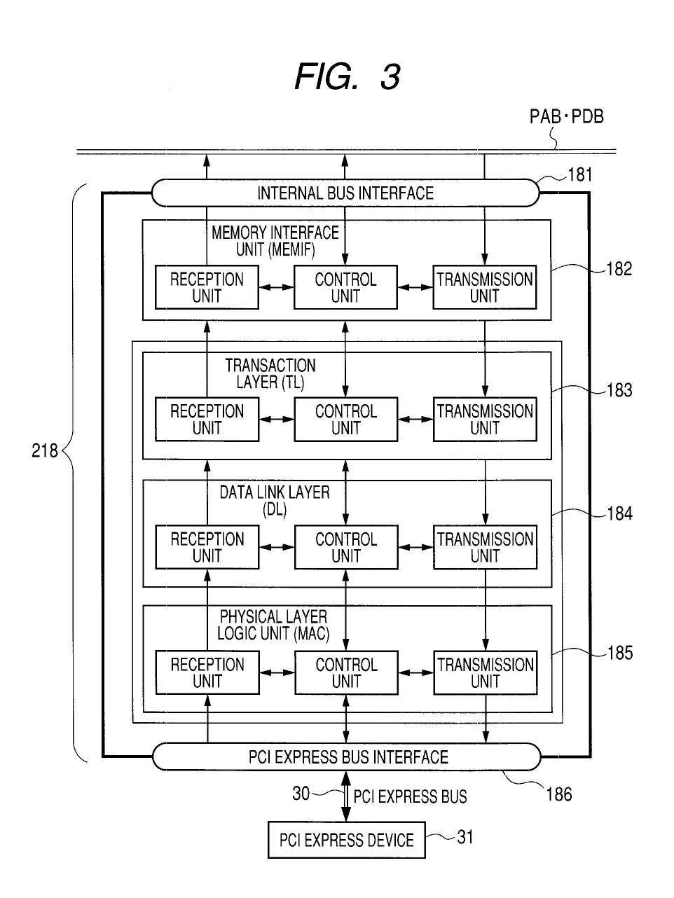

FIG. 3 shows an example of a structure of the PCI Express block 18 mentioned above.

The PCI Express block 18 is comprised of an internal bus interface 181, a memory interface unit (MEMIF) 182, a transaction layer (TL) 183, a data link layer (DL) 184, a physical layer logic unit (MAC) 185, and a PCI Express bus interface 186, though it is not particularly limited thereto.

The internal bus interface 181 is coupled to the buses PAB and PDB. The PCI Express bus interface 186 is coupled to another PCI Express device 31 via a PCI Express bus 30 coupled to outside of the microcomputer 210.

The transaction layer (TL) 183 is positioned on the uppermost level and has the function of assembling (composing) and disassembling a transaction layer packet. The transaction layer packet is used to transmit transactions such as read/write transactions and various events. The transaction layer (TL) 183 also performs flow control using a credit for the transaction layer packet.

The data link layer (DL) 184 ensures the data integrity of the transaction layer packet through error detection/correction (retransmission) and performs link management. The data link layer (DL) 184 also performs the reception/transmission of a packet for link management or flow control.

The physical layer logic unit (MAC) 185 includes circuits required for an interface operation such as a driver, an input buffer, a parallel-serial converter, a serial-parallel converter, a PLL (Phase-Locked Loop), and an impedance matching circuit.

Each of the memory interface unit (MEMIF) 182, the transaction layer (TL) 183, the data link layer (DL) 184, and the physical layer logic unit (MAC) 185 mentioned above includes a reception unit for receiving a packet via the PCI Express bus 30, a transmission unit for transmitting a packet via the PCI Express bus 30, and a control unit for controlling the operations of the reception unit and the transmission unit mentioned above.

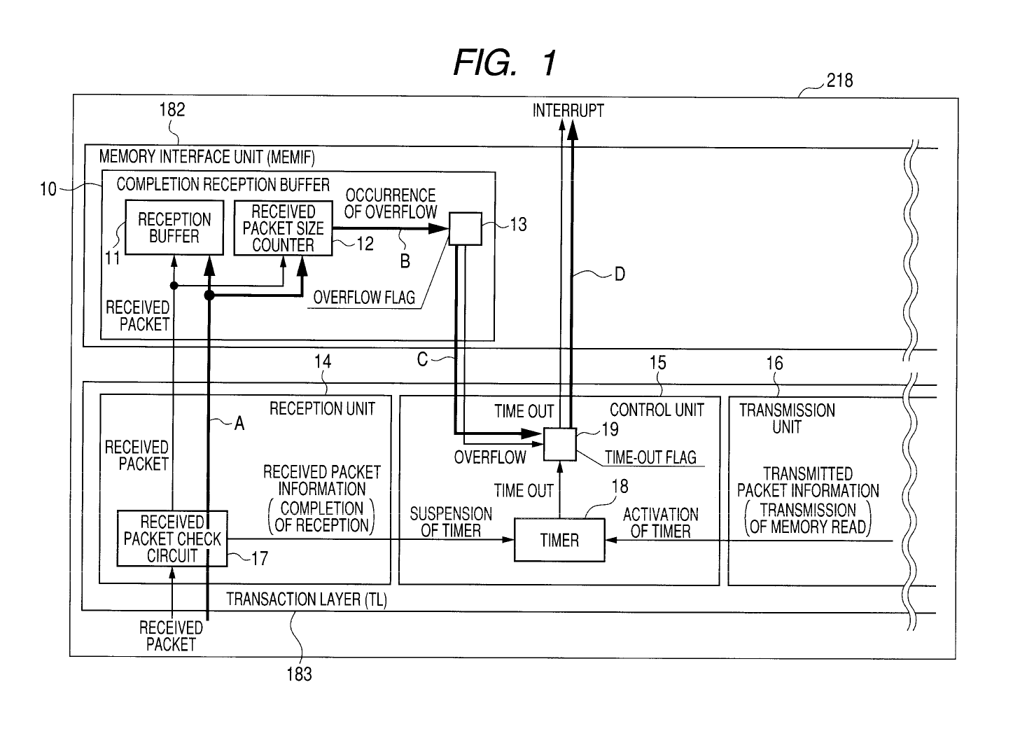

FIG. 1 shows the principal structures of the memory interface unit (MEMIF) 182 and the transaction layer (TL) 183, each mentioned above.

The memory interface unit (MEMIF) 182 mentioned above includes a reception buffer 11 for retrieving a received packet transmitted via the transaction layer (TL) 183, a received packet size counter 12 for counting the size of the received packet retrieved by the reception buffer 11 mentioned above via the transaction layer (TL) 183, and an overflow flag set register 13 which allows the setting of an overflow flag. The received packet is transmitted to the reception buffer 11 and the received packet size counter 12, as indicated by the arrow A. The overflow flag is set in an overflow flag set register 19, as indicated by the arrow B. The data size of the received packet is counted by the received packet size counter 12 mentioned above. When the data size of the received packet exceeds the size of the reception buffer, the overflow flag in the overflow flag set register 13 is set to, e.g., a logic value “1”.

The transaction layer (TL) 183 mentioned above includes a reception unit 14, a control unit 15, and a transmission unit 16. The reception unit 14 includes a received packet check circuit 17 for checking a received packet. The received packet check circuit 17 allows received packet information, such as “Completion of Reception”, to be obtained. When the reception of a packet is completed, a timer suspension signal is asserted by the received packet check circuit 17. The control unit 15 includes a timer 18 for detecting the case (time out) where there is no response from a completer within a preset time and a time-out set register 19 in which a time-out flag is set based on the result of the time-out detection by the timer 18. The timer 18 is activated by transmission unit packet information (memory read transmission) and suspended by the received packet information from the received packet check circuit 17. When the time out is detected by the timer 18, the time-out flag mentioned above is set to the logic value “1”, though it is not particularly limited thereto. When the overflow flag in the overflow flag set register 13 mentioned above is set to the logic value “1”, the time-out flag in the time-out flag set register 19 is set to the logic value “1” irrespective of the detection of the time-out by the timer 18, as indicated by the arrow C. When the time-out flag is set to the logic value “1”, an interrupt to a CPU 12 (see FIG. 2) is generated, as indicated by the arrow D. The CPU 12 can retransmit the request to the completer by an interrupt process resulting from the time-out flag.

A description will be given herein to the case where an interrupt request resulting from the occurrence of an overflow is not issued in split-transaction communication, as a target of comparison made with the structure mentioned above.

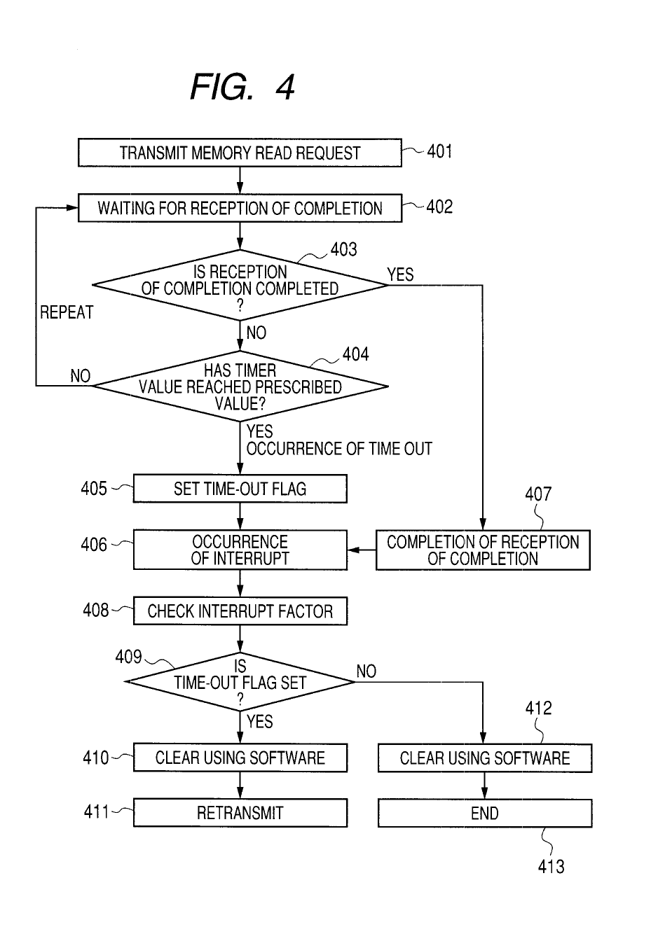

FIG. 4 shows a process flow when the interrupt request resulting from the occurrence of an overflow is not issued.

First, the PCI Express block 18 functioning as the requester transmits a request for a memory read to the PCI Express device 31 (401) and shifts to a state waiting for the reception of a completion (402). Then, the received packet check circuit 17 determines whether or not the reception of a completion is completed (403). When it is determined that the reception of a completion is not completed (N), it is determined in the timer 18 whether or not the timer value has reached a prescribed value (404). When it is determined that the timer value has reached the prescribed value (Y), the time-out flag is set in the time-out set register 19 (405). As a result, an interrupt to the CPU 212 is generated (406). The interrupt is also generated (406) when it is determined in the foregoing step 403 that the reception of a completion is completed (Y)(407). Then, an interrupt factor is checked by the CPU 212 and it is determined whether or not the time-out flag is set in the time-out set register 19 (409). When it is determined that the time-out flag is set in the time-out set register 19, the register or the like is returned to the initial state by the interrupt process to the CPU 212 (clearing using software), and the memory read request is retransmitted (411). When it is determined in the foregoing step 409 that the time-out flag is not set (N), clearing using software is performed (412), whereby a sequential process in split-transaction communication is ended (413).

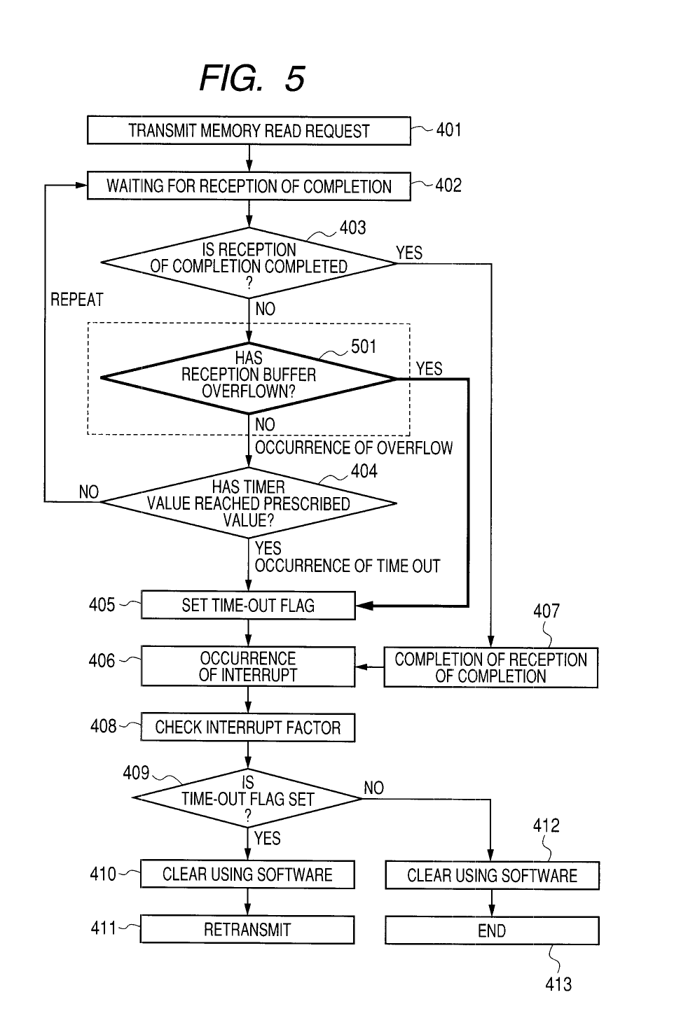

FIG. 5 shows a process flow when the interrupt request resulting from the occurrence of an overflow is issued.

The process shown in FIG. 5 is greatly different from the process in FIG. 4 in that it is determined whether or not the reception buffer 11 has overflown when it is determined in the step 403 that the reception of a completion is not completed (N) and, when it is determined that the reception buffer 11 has overflown (Y), the time-out flag is set (405). That is, it is determined in the received packet size counter 12 whether or not the reception buffer 11 has overflown and, when the reception buffer 11 has overflown, the overflow flag is set in the overflow flag set register 13. When the overflow flag is set in the overflow flag set register 13, the time-out flag is set in the time-out flag set register 19 in response thereto so that an interrupt equivalent to that generated when it is determined in the step 404 that the time out mentioned above is issued is generated. As a result, when the overflow flag is set in the overflow flag set register 13 in the present example, the retransmission of the memory read request is performed by the interrupt process even within the prescribed time for time-out determination (411).

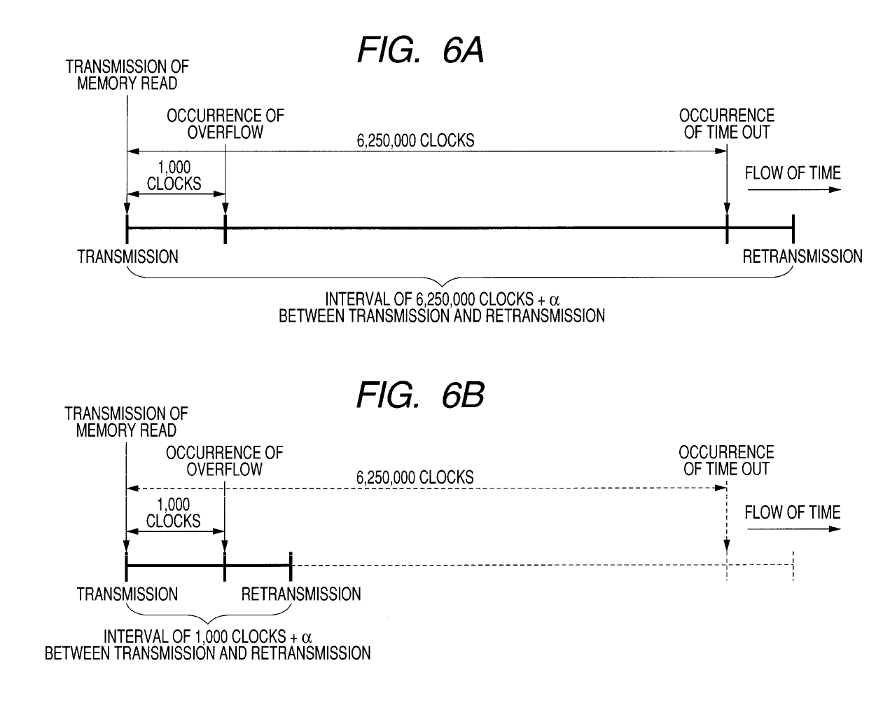

As shown in FIG. 4, in the case where the interrupt request resulting from the occurrence of an overflow is not issued, the time out is not issued before the prescribed time elapses even when the reception buffer of a transaction initiator (requester, request receiver) has overflown with a response from a transaction partner (completer, request transmitter), so that the efficiency of the request retransmission is degraded. For example, in the case where a time equivalent to 6,250,000 clocks is required from the transmission of the memory read request till the occurrence of the time out as shown in FIG. 6(A), when the reception buffer of the transaction initiator has overflown, a time equivalent to (6,250,000 clocks+a) is required till the retransmission, which causes the degradation of the efficiency of request retransmission.

By contrast, in the case where the interrupt request resulting from the occurrence of an overflow is issued as shown in FIG. 5, the overflow flag is set when the reception buffer 11 has overflown, and the time-out flag is set in response thereto. Accordingly, the retransmission of a memory read request is performed at a time after the lapse of a time equivalent to (1,000 clocks+a) from the transmission of the request, as shown in, e.g., FIG. 6(B). As a result, in the case where the interrupt request resulting from the occurrence of an overflow is issued, the efficiency of request retransmission is significantly improved.

In accordance with the example shown above, the following operation and effect can be obtained.

(1) In the case where the interrupt request resulting from the occurrence of an overflow is issued, the overflow flag is set when the reception buffer 11 has overflown, and the time-out flag is set in response thereto. Accordingly, even within the prescribed time for time-out determination, the process of issuing the time out is allowed so that the efficiency of request retransmission is significantly improved compared with the case where the interrupt request resulting from the occurrence of an overflow is not issued.

(2) By checking the overflow flag in the interrupt process when the time out is issued, it is possible to recognize the frequency with which the overflow flag is set. The information is regarded as significant information to, e.g., system debug.

Although the invention achieved by the present inventors has thus been described specifically, the present invention is not limited thereto. It will be easily appreciated that various modifications can be made in the invention without departing from the gist thereof.

Although the description has thus been given primarily to the case where the invention achieved by the present inventors is applied to the microcomputer, which is a field of application serving as the background of the invention, the present invention is not limited thereto and is widely applicable to semiconductor integrated circuit devices.

The present invention can be applied on the condition that it comprises at least a high-speed serial interface block which allows split-transaction communication.

What is claimed is:

1. A semiconductor integrated circuit device having a high-speed serial interface block which enables split-transaction communication performed through issuing of a response from a completer to a request issued by a requester,
wherein the high-speed serial interface block comprises:
a reception buffer for retrieving received data; and
a control unit for causing execution of a process which is performed in the case where there is no response from the completer within a predetermined time when the reception buffer has overflown.

2. A semiconductor integrated circuit device comprising:
a high-speed serial interface block which enables split-transaction communication performed through issuing of a response from a completer to a request issued by a requester,
wherein an interrupt process for request retransmission is performed by setting a time-out flag when there is no response from the completer within a predetermined time, and
wherein the high-speed serial interface block comprises:
a reception buffer for retrieving a received packet;
a received packet size counter capable of detecting an overflow in the reception buffer by counting a size of the packet received by the reception buffer; and
a control unit for causing execution of a predetermined interrupt process by setting the time-out flag, when the overflow in the reception buffer is detected by the received packet size counter, in response thereto.

3. A semiconductor integrated circuit device according to claim 2, further comprising:
a first resister in which the time-out flag is set when there is no response from the completer within the predetermined time; and
a second register in which an overflow flag is set when the overflow in the reception buffer is detected by the received packet size counter,
wherein the time-out flag is set in the first register, when the overflow flag is set in the second register, in response thereto.

4. A semiconductor integrated circuit device according to claim 3, further comprising:
a central processing unit capable of executing the interrupt process for request retransmission when the time-out flag is set in the first register.

5. A microcomputer comprising:
a high-speed serial interface block which enables split-transaction communication performed through issuing of a response from a completer to a request issued by a requester; and
a central processing unit coupled to be capable of transmitting and receiving various signals between itself and the high-speed serial interface block, wherein
an interrupt process for request retransmission is performed in the central processing unit by setting a time-out flag when there is no response from the completer within a predetermined time,
wherein the high-speed serial interface block comprises:
a reception buffer for retrieving a received packet;
a received packet size counter capable of detecting an overflow in the reception buffer by counting a size of the packet received by the reception buffer; and
a control unit for causing the central processing unit to execute the interrupt process for request retransmission by setting the time-out flag, when the overflow in the reception buffer is detected by the received packet size counter, in response thereto.

6. A microcomputer according to claim 5, further comprising:
a first register in which the time-out flag is set when there is no response from the completer within the predetermined time; and
a second register in which an overflow flag is set when the overflow in the reception buffer is detected by the received packet size counter,
wherein the time-out flag is set in the first register without determining whether or not there is a response from the completer when the overflow flag is set in the second register.
